(19) United States
(12) Patent Application Publication
(10) Pub. No.: US 2005/0125405 A1
(43) Pub. Date: Jun. 9, 2005

(54) Distinct display of differentiated rights in property

(75) Inventors: Stephen Watson, Toronto (CA); Michael A. Malcolm, Aspen, CO (US)

Correspondence Address: SWERNOFSKY LAW GROUP PC, P.O. BOX 390013, MOUNTAIN VIEW, CA, 94039-0013, US

(73) Assignee: Kaleidescape, Inc., Mountain View, CA (US)

(21) Appl. No.: 10/964,566

(22) Filed: Oct. 12, 2004

Related U.S. Application Data
(63) Continuation-in-part of application No. 10/418,739, filed on Apr. 18, 2003.

(51) Int. Cl. G06F 17/30; G06F 17/00

(52) U.S. Cl. 707/7; 707/104.1; 707/4; 707/5

(57) ABSTRACT

The invention provides a method and system capable of interacting with a server device, with the effect of being able to conveniently present, in a distinct way, those objects not already owned by the user. Multiple views of collections of objects are presented to the user. The portion of the view that reflects objects not owned by the user is degraded in such a way that the user is able to quickly surmise the objects not yet owned. The view may include fractionally degraded and completely degraded views such that fractionally degraded views indicate another aspect of an object. For example, an object may be local to the user but the user may not have licensed the use the object, or the degraded view may indicate that the object is not yet available but it will be available shortly. Users can decide whether to take action based on the presentation.

### CROSS-REFERENCE TO RELATED APPLICATION

This application is based upon and claims priority of U.S. patent application Ser. No. 10/418,739, filed Apr. 18, 2003, titled “Mosaic-Like User Interface for Video Selection and Display”, attorney docket number 217.1018.01, hereby incorporated by reference as if fully set forth herein. This document is sometimes referred to herein as the “incorporated disclosure”.

Inventions described herein can be used in combination or conjunction with technology described in the incorporated disclosure.

### BACKGROUND OF THE INVENTION

1. Field of the Invention

The invention relates to distinct display of rights (as broadly defined, whether to goods or services, tangible or intangible, permanent or evanescent, and the like), such as for example a degraded display of movie poster icons for those movies for which the user does not have a license to playback.

2. Related Art

Movies and other audio and/or visual presentations on mediums such as DVD's have exploded in popularity in recent years. Many consumers are not only buying recently released material, but they are also replacing older formats such as video tape with newer high quality replacements. It can difficult; however, for the user to maintain the knowledge of the titles they already own, and it would be undesirable for the user to own more than one copy of a movie unless they really want to. This is also true for many other types of collectables such as, Lladro, baseball cards, Beanie Babies, stamps, and the like.

A user's likes and dislikes for media streams typically involve one or more genres, such as “action” films, or “western” films. It is, however, difficult to easily present all films likely to be wanted by the user and yet not owned by the user in a convenient and easily-understood format.

This problem is solved in part by the “guide” and “mosaic” techniques for presentation of movie titles or movie posters (as described in the incorporated disclosure), but there is no convenient method for distinguishing which of those movies are already owned by the user (and thus available for immediate presentation) and those which are not yet owned by the user (and thus only available after download or ingestion).

A user may also want to maintain a collection of all movies of a particular kind, and yet after such a collection is completely purchased, new movies of that kind may be produced or released for distribution. For example, “all Star Wars films” would be updated every time there is a new such film, and “all episodes of Survivor” would be updated every time there is a new such episode (possibly as often as once per week). It would be advantageous to identify to the user the media streams they do not already own, so that they are able to purchase them and complete their collections.

Another known partial solution is the “shopping cart” model, but this does not provide any convenient means of ensuring that the user does not purchase media streams they already own, nor does this partial solution make use of portraying close together titles that are similar to one another.

Another problem is that maintaining a list of movies that the user owns can be labor intensive. For example, users can manually type the titles of their movies into a database. A known solution is to compute a hash of the media stream and use this as a key in a database to retrieve metadata about the media stream. This solution, however, does not provide any means of portraying close together titles that are similar to one another nor does it provide any means for portraying movies not owned by the user.

Accordingly, it would be advantageous to provide a technique for interacting with a presentation device, with the effect of being able to conveniently present media streams so that similar titles are grouped together, and so that those media streams not already owned by the user are portrayed in a distinct manner.

### SUMMARY OF THE INVENTION

The invention provides techniques, including methods and systems, capable of distinct display of rights (as broadly defined, whether to goods or services, tangible or intangible, permanent or evanescent, and the like), such as for example a degraded display of movie poster icons for those movies for which the user does not have a license to playback. In preferred embodiments, the invention provides methods and systems capable of interacting with a server device, with the effect of being able to conveniently present, in a distinct way, elements representing those objects in which a user does and does not possess selected rights (such as a right to playback media or such as a property interest).

A system presents a set of descriptive elements (such as, miniature movie posters) on a display device with the effect that the elements have a screen position closeness that is in response to the closeness of the objects they represent in a space of object descriptions. Screen position closeness can be the mosaic format or the guide format, for example as further described in the incorporated disclosure, in response to a connectedness graph (such as which movies share movie stars or directors), or in response to a user-defined metric, such as a weighted average or Boolean computation.

Using a touch panel or other CE (consumer electronics) device (such as a remote control, PDA, mobile phone, PC (personal computer) and/or its peripherals) or other appropriately enabled device, the user can select an element or a group of elements presented on the on-screen display. The user can simply select an element by pressing a button on the touch panel while that element is in focus. In an alternative embodiment, the user can select elements by outlining a group of elements with a rectilinear box of the mosaic, or a circle with center and radius on the mosaic, or an ellipse with foci on the mosaic, or draw an enclosing line on the mosaic, or draw similar distinctions on a non-mosaic presentation.

The system can present the elements differently in response to attributes. For example, if the corresponding objects are movies, the elements might be displayed differently such as; 1) whether they are marked as favorites; 2) whether the movies have been speculatively downloaded and are therefore available for “instant purchase”; 3) whether the user owns or has a right to play those movies, either right now or at a selected future time; 4) whether those movies have been played, either recently or at selected past times; 5) whether those movies are authorized for that particular user (such as for example for parental control); 6) whether those movies are recommended by another entity, such as another user or service provider; 7) whether those movies are on a list of movies the user wishes to see “soon” (similar to a to-do list).

The system includes multiple presentation methods for presenting the elements differently, so that it is easy for the user to distinguish between those objects with multiple attributes such as whether the user does or does not have rights to the objects. The presentation methods include; 1) black and white vs. color, 2) box-highlighted vs. not highlighted, 3) animated vs. non-animated, 4) scrolling marquee vs. non-scrolling, 5) three dimensional graphics vs. two dimensional graphics and the like.

The user may or may not be granted control to select the presentation method, attributes, and a host of other features as explained herein. The current view of each element may be expanded or contracted so more or less detail is presented to the user. The method or type of display may be changed while maintaining the essential metadata such as the title of each object.

The system can perform an action on the selected elements where the action the system performs can be:
Buy all those objects;
Select all those objects for try-and-buy, rental, playing the trailer, or other enticements to the user to buy them;
Allow the user to mark the selected objects as favorites for later recall, such as for example, “Steven Swernofsky is thinking of buying these objects”;
Speculative download of objects a user may later purchase based on a calculated statistical attribute showing confidence of a future purchase.

In each case, if performing the action causes a change in an attribute of the objects selected, and if the presentation method for those elements is in response to that attribute, then the presentation of those elements will be changed either instantly or after some confirmation that the action will be successful.

The selection of elements may create a collection defined by the user, which is unrelated to whether the user does or does not own the objects, but which causes the system to perform an action, where the action the system performs can be:
Re-display the space of elements in response to that collection, that may represent “their favorite” objects, for example by sorting the space of elements to move such favorites together;
Re-display the space of elements using a different technique (such as using the mosaic instead of the grid, or vice versa), but giving priority to the selected collection.
Allow the user to mark a collection for later recall, such as for example, “Steven Swernofsky likes these objects.”

The system displays elements on screen differently in response to attributes of the corresponding objects. Attributes can include factors about ownership of those objects and the user will make their selections in response to those displays.

The system includes database functionality that provides the user with the ability to manage a fully functional database that is automatically populated with at least some information regarding all objects on the system. This information may be extracted from the objects where the objects are digital in nature (such as, audio and video) or through object descriptive data provided by the owner granting the user rights to the objects.

After reading this application, those skilled in the art would recognize that the invention provides an enabling technology by which substantial advance is made in the art of user interfaces for distinctly displaying the rights of a user to objects and the ability of the user to conduct business transactions to secure rights to objects.

Accordingly, it would be advantageous to provide a technique for distinct display of differentiated rights in property.

### BRIEF DESCRIPTION OF THE DRAWINGS

FIG. 1 shows a block diagram of a system including a user interface for

interacting with a server device, with the effect of being able to distinctly display objects with differentiated user rights.

FIG. 2 illustrates a view in a system for distinctly displaying objects with differentiated user rights. FIG. 2 is illustrative of a view and is not intended to be limiting in any way.

FIG. 3 illustrates a set of view boxes displaying additional information.

FIG. 4 shows a process flow diagram of a method including operation of a system for distinctly displaying objects with differentiated user rights.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Definitions

The general meaning of each of these following terms is intended to be illustrative and in no way limiting.
The phrase “media stream” describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that “media streams” must be delivered continuously. Also as described herein, media streams can refer to other information for presentation, such as for example animation or sound, as well as to still media, such as for example pictures or illustrations, and also to databases and other collections of information.
The phrase “digital content” describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.
The phrase “digital media,” and the like, describes physical media capable of maintaining digital content in an accessible form. Digital media includes disk drives (including magnetic, optical, or magneto-optical disk drives), as well as any other physical media capable of maintaining information, such as digital content.
The term “DVD,” or the phrase “digital versatile disc,” and the like, refer to a technology standard that describes the storage of data on optical discs. Like the CD (compact disc), a DVD holds its information in a digital format as pits denoting ones and zeros on the surface of the disc.

The scope and spirit of the invention is not limited to any of these definitions, or to specific examples mentioned therein, but is intended to include the most general concepts embodied by these and other terms.

System Elements

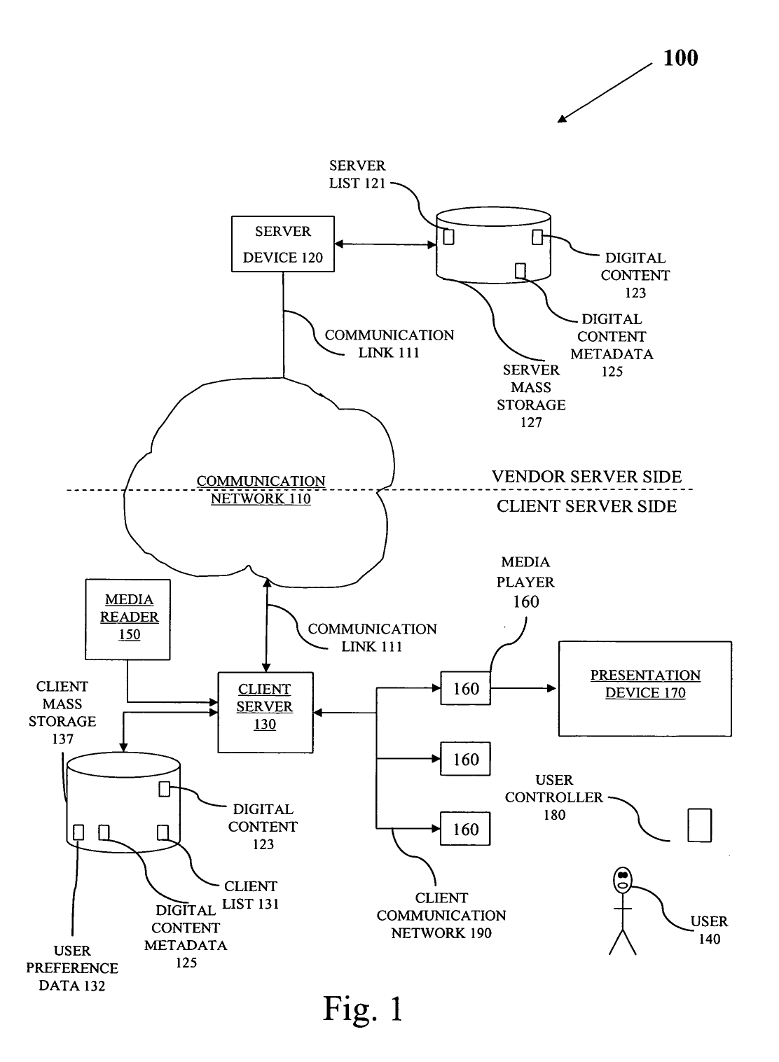

FIG. 1 shows a block diagram of a system including a user interface for interacting with a server device, with the effect of being able to distinctly display elements representing objects with differentiated user rights. For illustrative purpose, digital media streams have been used as an example of an object type for which the invention may be applied. The object types that may be used with the invention are practically without limitation. Many other object types are listed as examples herein to illustrate the diversity of application but are not intended to be limiting in any way.

A system 100 includes a communication network 110, a vendor server 120, a client server 130, a user 140, a media reader 150, a media player 160, a presentation device 170, a user controller 180, and a client communication network 190.

The communication network 110 includes at least a portion of a communication network, such as a LAN, a WAN, the Internet, an intranet, an extranet, a virtual private network, a virtual switched network, or some combination thereof. In a preferred embodiment, the communication network 110 includes a packet switched network such as the Internet, as well as (in addition to or instead of) the communication networks just noted, or any other set of communication networks that enable the elements described herein to perform the functions described herein.

A communication link ill operates to couple the elements of the system 100 such that the elements can communicate between each other as further described herein.

A vendor server 120 includes a processor, a main memory, a server mass storage 127, and software for executing instructions (not shown, but understood by one skilled in the art). This software preferably includes communications and control software capable of operating the vendor server 120 consistent with the invention as further explained herein.

The server mass storage 127 includes a server list 121, digital content 123, and digital content metadata 125. The server mass storage 127 preferably includes a hard disk storage medium. In alternative embodiments, the server mass storage 127 can include any combination of magnetic drives, optical drives, and silicon chip storage.

The server list 121 includes a comprehensive list of available digital content 123 and associated digital content metadata 125.

Digital content 123 includes audio, video, and combinations thereof as used to present sound and images. For example, but without limitation, digital content 123 can include; movies and songs as might be present on digital media such as Compact Discs, DVDs, Digital Audio Tape, and electronic computer storage devices.

Digital content metadata 125 includes information specific to a particular media stream or group of media streams. This information includes both information intrinsic to the media stream (such as aspect ratio, running time, MPAA rating, actors) and information extrinsic but closely related (such as price and availability).

A client server 130 includes a processor, a main memory, a client mass storage 137, and software for executing instructions (not shown, but understood by one skilled in the art). This software preferably includes communications and control software capable of operating the client server 130 consistent with the invention as further explained herein.

The client mass storage 137 includes a client list 131 and digital content 123. The client mass storage 137 preferably includes a hard disk storage medium. In alternative embodiments, the client mass storage 137 may include any combination of magnetic drives, optical drives, and silicon chip storage.

The client list 131 includes a database of all digital content 123 owned by the user 140 and user preference data 132. The client list 131 includes a cross-reference to digital content metadata 125.

A media reader 150 includes a processor, a main memory, and software for executing instructions (not shown, but understood by one skilled in the art). This software preferably includes communications and control software capable of operating the media reader 150 consistent with the invention as further explained herein. The primary task of the media reader 150 is to ingest media streams to the client mass storage 137 from media such as, DVD's and CD's.

In an alternative embodiment of the invention, the media reader 150 includes a device capable of identifying hard goods (items in a physical form as opposed to those in an electronic form) for example; a radio frequency identification device, a bar code reader, or similar device. The media reader may also include the ability to capture an image of an item to be associated with the item and used in displaying information to the user 140 as further explained herein.

A media player 160 includes a device capable of generating a displayable image and/or sound from digital data. A user 140 can have multiple units. Generally, one unit is present at each location when a presentation will take place.

A presentation device 170 includes a device capable of presenting images and sound to a user 140. In a preferred embodiment, the presentation device 170 includes one or more of a CRT type television set, a plasma display, a video projector and screen.

A user controller 18o includes a device capable of controlling the elements of the system 100 on the client server side. In a preferred embodiment, the user controller 180 includes a consumer electronics device. In alternative embodiments, the user controller 180 may include a laptop computer, tablet computing device, a personal data assistant (PDA), a cellular phone, or a dedicated device including all the elements attributed to such as described herein. The user controller 180 may be hardwired to one or more elements of the system 100 on the client server side or it may be a wireless device.

The client communication network 190 includes a local area network capable of allowing the client server side devices to communicate. In a preferred embodiment the client communication network 190 includes a 100Base-T Ethernet, however, any other communication network type may be used that supports the necessary bandwidth for presentation of digital content 123.

Method of Operation

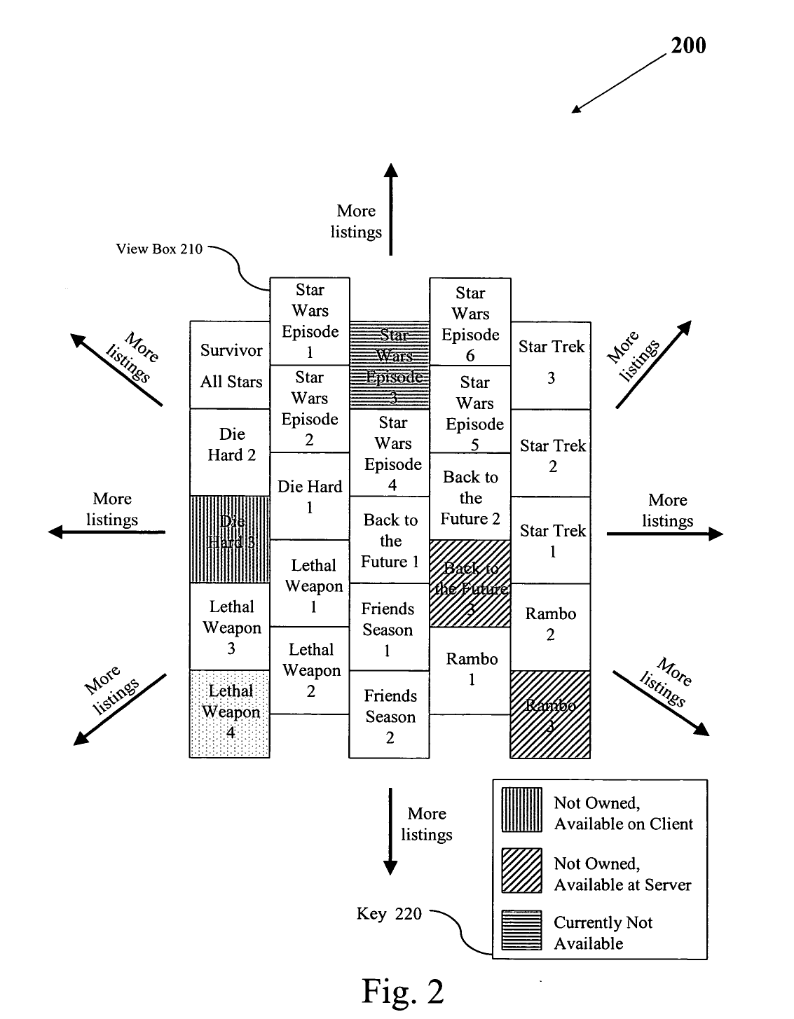

FIG. 2 illustrates a view in a system for distinctly displaying objects with differentiated user rights. FIG. 2 is illustrative of a view and is not intended to be limiting in any way.

The system includes functionality to populate the client list 131 automatically. In a preferred embodiment, all media streams present on the client server 130 would correspond to an associated entry in the database of the client list 131. New entries are added automatically when a user 140 purchases a media stream, and new entries are added automatically when the system pre-downloads media streams that the user 140 has not yet purchased. Information used to populate the client list 131 and digital content metadata 125 is downloaded from the server device 120. A hash is computed from each media stream to identify it. Information contained at both the vendor server 120 and the client server 130 is protected from unauthorized use and tampering. Access is authenticated using passwords or other security processes known by those skilled in the art.

A view 200 includes a plurality of view boxes 210.

A view box 210 includes information concerning at least one media stream. In a preferred embodiment each view box 210 contains information on a single media stream. For example, the view box 210 could include a miniaturized version of a movie poster associated with the media stream. In alternative embodiments, a view box 210 may contain information on multiple media streams such that all user-owned media streams of a specific type are identified within a single view box 210. For example, in an alternative embodiment, if a user 140 owns four Star Wars movies, they would preferably all appear listed in a single view box 210. Any remaining Star Wars movies would appear separately or together in other view boxes in a degraded view. This would allow the display to be somewhat compressed.

As previously stated, media streams are used herein to be illustrative of an object which may be practically any physical or digital object. For other popular collectables currently in vogue, a view box 210 could include a picture of the object. Thus, a view box 210 could include a picture of a Beanie Baby, a baseball card, a Lladro figurine, or other object. The picture can be provided via an electronic transfer from the vendor server 120 to the client server 130 or by the user 140 generating the picture using the media reader 150.

A central view box 210 is generally the view box 210 presented at the center of all other view boxes presented on the presentation device 170. In FIG. 2, “Back to the Future 1” is the central view box 210. Displayed view boxes 210 spawn outward from the central view box 210.

The view 200 illustrated in FIG. 2 is a portion of what might be available to the user 140. By scrolling horizontally, vertically, or diagonally, the user 140 is able to see “more listings.” Although the user 140 will have a limited number of media streams that will display, there is no apparent limit for scrolling in any direction. View boxes 200 are essentially mapped to a sphere that the user 140 can see a portion of. If the user 140 scrolls continuously in one direction they will simply return to their point of origin.

Each view box 210 may be individually formatted with one or more combinations of visual changes. The visual changes indicate the status of the media stream or streams associated with the view box 210. The status of a view box 210 includes but is not limited to:
Owned
Not owned, available at server
Not owned, available on client
Scheduled for sales release (date shown)
Scheduled for theatrical release (date shown)
Currently in theatrical release
Currently not available
Recently played (date shown)
In transit (Purchased but not yet available for playback)

A key 220 includes a legend to the visual changes. The key 220 is displayed with the view 200 or is displayable upon the request of the user 140. In FIG. 2, as an example, Die Hard 3 is shaded with vertical lines (enhanced/degraded). The key 220 indicates that this means Die Hard 3 is not owned by the user 140. Star Wars Episode 3 is shaded with horizontal lines indicating that the title is currently not available (True as of September 2004). Both Rambo 3 and Back to the Future 3 are shaded with left sloping diagonal lines indicating these titles are not owned by the user 140, but they have been pre-downloaded so the user 140 can watch them immediately after purchasing them without delay as no download time will be necessary.

The number of types of view box 210 formatting is practically without limit. The view boxes 210 may include animation, depleted or excessive brightness or hue, highlighting, back-highlighting, box-highlighting, additional text, moving text, shading, scrolling marquees, sound and combinations thereof. In a preferred embodiment, the view boxes appear in a two-dimensional array.

Multiple degraded/enhanced views 200 are possible and user-selectable. In a most basic view 200, each media stream would be associated with a view box 210. View boxes 210 associated with media streams not owned by the user 140 would be grayed out (monochrome or colored pixels with less brightness) making them extremely easy to identify among all the other displayed view boxes 210. In this particular example, the view boxes 210 associated with media streams that are not owned by the user 140 are degraded. Alternatively, the view boxes 210 associated with media streams that are not owned by the user 140 can be enhanced. In this embodiment, owned media streams would be grayed out (or otherwise degraded) and those not owned would appear lit (or would otherwise be enhanced).

View boxes 210 may be used to display additional information to assist the user 140 and enhance system efficiency. This information includes but is not limited to; Media Stream Title, Purchase Price, Running Time, Aspect Ratio, Languages, Audio Specifications, Inclusion of Additional Features, Number of Seasons in a Series, Number of Sequels in a Series, Soundtrack Availability, Soundtrack Price, MPAA rating.

For other items that are not media streams, appropriate relevant additional information would be displayed. The following indicate some examples of information that might be tracked, and the user would be able to add their own additional information.
Lladro—Figurine title, date of manufacture, quantity made
Baseball cards—Player name, team, card condition
Beanie baby—Baby name, color, size
Stamps—Country, face value, condition
Books—Title, genre, year published, value
Paintings—Artist, genre, year, value

In a preferred embodiment, the additional information would be displayed as a default; however, in an alternative embodiment the additional information would only display at the request of the user 140. The alternative embodiment allows more view boxes 210 to be displayed on the presentation device 170 at one time as less information for each view box 210 is displayed.

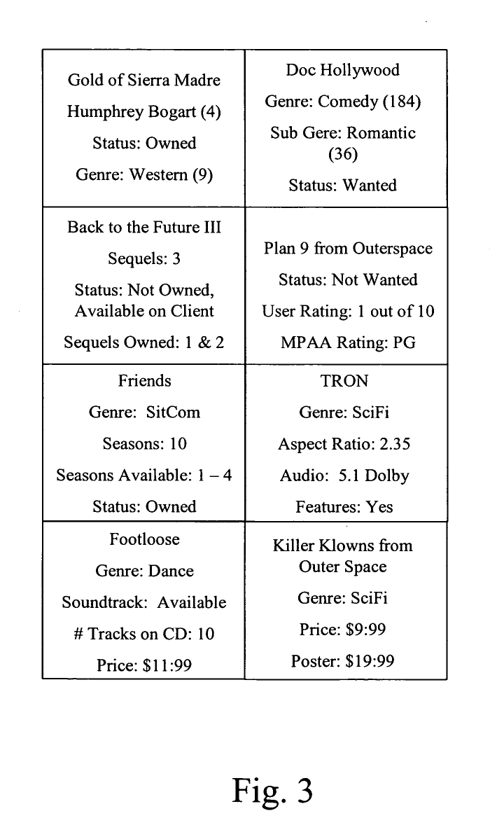

FIG. 3 illustrates a set of view boxes displaying additional information.

The types of additional information are practically without limit, and as an added bonus the user 140 receives a fully populated, informative, and functional database of their collection of media streams.

The user 140 is free to determine exactly what additional information (if any) is displayed in a view 200. Such a selection of additional information may be stored by the user 140 on the client mass storage 137 as user preference data 132.

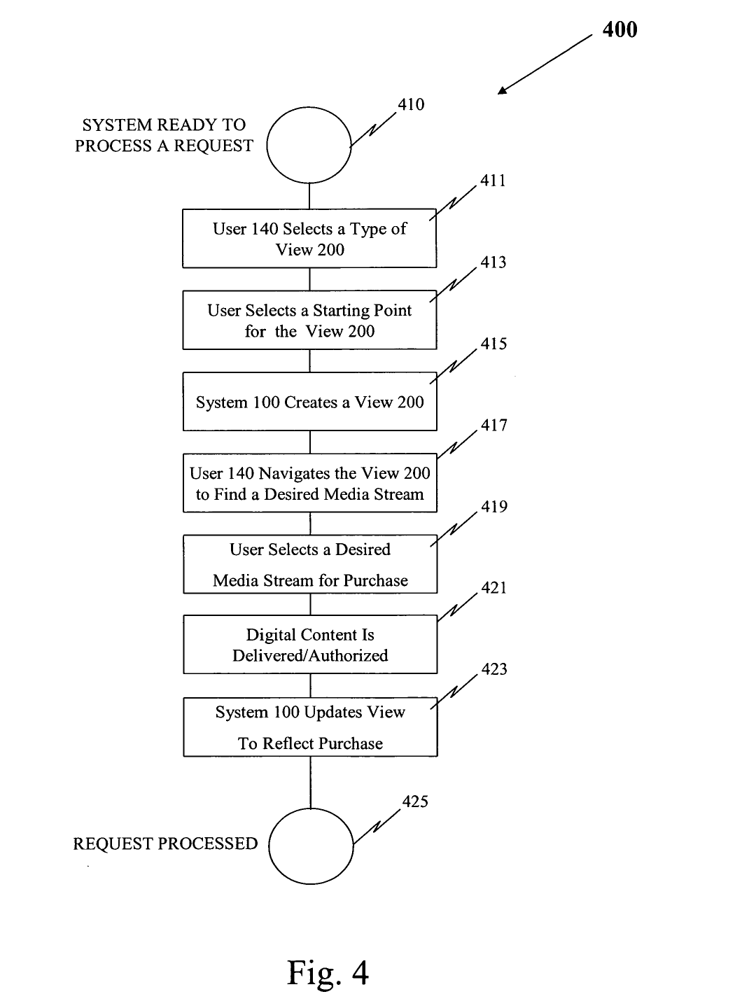

FIG. 4 shows a process flow diagram of a method including operation of a system for distinctly displaying objects with differentiated user rights.

A method 400 includes a set of flow points and steps. Although described is serially, these flow points and steps of the method 400 can be performed by separate elements in conjunction or in parallel, whether asynchronously or synchronously, in a pipelined manner, or otherwise. There is no particular requirement that the flow points or steps must be performed in the same order as described, except where explicitly so indicated.

At a flow point 410, the system 100 is ready to process a request.

At a step 411, the user 140 selects a type of view 200 using the user controller 180. In a preferred embodiment, many predefined views 200 exist from which the user 140 may choose. The user 140 may also define their own set of views 200 as previously explained. The predefined and user-defined views 200 reside in the client mass storage 137 as user preference data 132.

At a step 413 the user 140 selects a starting point for the view 200. The view 200 is preferably generated outward from a central starting point such that each view box 210 is related to a central view box 210 that it touches based on some criteria as further explained in the incorporated disclosure. For example, the user may choose a view that asks for a central tile of a science fiction movie and then spawns outward based on movies with similar attributes.

Most often, a starting point for a view 200 is inherited from an earlier view 200. It is anticipated that following the first starting point selected by a user 140 at the beginning of a session, most subsequent starting points selected by a user 140 will be inherited from an earlier view 200.

At a step 415 a view 200 is generated based on the selection of the user 140.

At a step 417 the user 140 navigates the view 200 to find desired media streams. The user 140 may view additional information concerning the media streams as previously explained. The user 140 may also set a new starting point by selecting a view box 210. Selecting a group of view boxes 210 may also be accomplished. In such a case, attributes of the media streams they represent are processed (such as, aggregated) to identify a new view box 210 as a starting point. A new view 200 is then generated based on the new starting point.

At a step 419 the user 140 selects a desired media stream for purchase. This is accomplished by selecting the view box 210 associated with the media stream. The user 140 is aware of the price and current location of the media stream because it is presented to them in the additional information. The media stream may have been pre-downloaded to the client server 130 in anticipation that the user 140 would want to purchase it. This causes the media stream to be even more appealing to the user 140 as the media stream can be watched immediately after purchasing it.

Although the step 419 is described with respect to purchase of a media stream, in various embodiments, the user might perform one or more of the following (relatively generic) operations with respect to any (relatively generic) type of object.
purchase that object, or in the case of digital content (whether or not that digital content represents a media stream), license that digital content for use;
rent that object, or in the case of digital content, license that digital content for use, such as for example for a specific number of uses or a specific time duration;
acquire other rights in that object, such as for example an option to purchase that object at some specified time in the future, such as for example for digital content, the option to purchase or license that digital content on its release date;
correct mistaken information represented by the attributes associated with that object, such as for example for the user to correct the “ownership” attribute of an object (such as for example to mark that object “owned” if the database inaccurately shows it as not owned);
introduce external information not already represented by the attributes associated with that object, such as for example for the user to correct the “ownership” attribute of an object if the user should sell or give the object to another person.

Moreover, although the step 419 is described with respect to a successful purchase, in various embodiments, the local server might determine whether the purchase might fail, such as under for example one or more of the following conditions.
The user attempts to conduct the business transaction (purchase, license, rental, or whatever), but there are insufficient items in stock for timely shipment. This would of course apply to physical objects, including physical media on which digital content (whether or not that digital content represents a media stream) is represented.
The user attempts to conduct the business transaction, but has insufficient credit for that transaction, or otherwise violates business rules associated with that object. For an example of the latter, the licensor might decide to allow only outright purchase of selected DVDs during the theatrical release of that movie, and to allow rentals only after that theatrical release time period has ended.
The user attempts to conduct the business transaction, but has inadequate storage on the local server to accommodate the digital content. In such cases, the user might be prompted to decide between (a) rejecting the transaction, or (b) purchasing more storage.
Similarly, the user attempts to conduct the business transaction, but has a version of the system that is incapable of presenting the media stream associated with that object. In such cases, the user might be prompted to decide between (a) rejecting the transaction, or (b) upgrading the system to make it so capable.

At a step 421 the media stream is delivered and/or authorized to the user 140. In some cases, digital content 123 is pre-downloaded to the client server 130. This may be in response to analysis of the client list 131 that indicates likelihood that the user 140 would want it, such as when it would complete a collection or if the user 140 has expressly identified the digital content 123 as “wanted.” When the digital content 123 is already present at the client server 130, the vendor server 120 need only verify payment and the identity of the user 140 to expedite the transaction. The digital content 123 can then be authorized without any wait for a download process of the digital content 123.

For physical objects, delivery can be accomplished by many common methods including a mail type delivery (UPS, FedEx, U.S. Mail, etc.) and/or pickup by the user 140.

When the digital content 123 is not already present at the client server 130, payment and identity verification is accomplished and the digital content 123 is sent to the client server 130.

At a step 423 the system 100 updates the current view 200 to reflect the purchase. It is important to note that the purchase process can be accomplished without any real time interaction from the user 140. This is accomplished when the user 140 identifies to the system 100 a status of “wanted” for a media stream. At regular intervals, the vendor server 120 and client server 130 can communicate such that the vendor server 120 is informed of the desire that the user 140 has for a particular media stream or group of media streams. If the media stream has become available, it is delivered to the user 140, the user 140 is billed, and the user 140 is notified by the system 100.

At a flow point 425, at least one media stream has been purchased by a user 140 and delivered to them. The system 100 is ready to start over at flow point 410.

### Alternative Embodiments

Although preferred embodiments are disclosed herein, many variations are possible which remain within the concept, scope, and spirit of the invention. These variations would become clear to those skilled in the art after perusal of this application.
The invention is not restricted to presentation of movies, but is also applicable to other media streams, such as for example video games, animation, still media, such as for example pictures or illustrations, and to presentation of databases and other collections of information, or of user interfaces associated with operating systems or application software. The invention is also equally applicable to books, beanie babies, Lladro and other physical objects. In such cases, radio frequency identification tags can be used for electronic tracking and identification.

Those skilled in the art will recognize, after perusal of this application, that these alternative embodiments are illustrative and in no way limiting.

1. A method, including steps of
defining a set of screen elements, each element of said set of screen elements being representative of at least one object;
maintaining a set of attributes associated with each said object in a database, said set of attributes including at least one attribute that indicates the rights of a user with respect to said object, and said set of attributes including at least one attribute that indicates the status of a business transaction, said steps of maintaining including updating said database from time to time;
presenting each said element on a display in one of a plurality of displayable forms, said displayable forms responsive to at least one of said set of attributes;
receiving a selection of at least one of said elements by a user; and
changing at least one attribute of said elements in response to said steps of receiving:

2. A method as in claim 1, wherein said business transaction includes at least one of: a purchase of an object, a rental of an object.

3. A method as in claim 1, wherein said business transactions include binding commitments by the user and an agent for a claimant of rights to that object.

4. A method as in claim 1, wherein said object includes digital data.

5. A method as in claim 1, wherein said object includes a physical object.

6. A method as in claim 1, wherein each element of said set of screen elements includes a pictorial representation of at least a portion of said object each said element is representative of.

7. A method as in claim 1, wherein said set of attributes includes at least one of: owned, not owned, scheduled for sales release, scheduled for theatrical release, currently in theatrical release, currently not available, recently played, in transit.

8. A method as in claim 1, wherein said at least one attribute that indicates the status of a business transaction is responsive to the occurrence of a business transaction between a user and an agent for a claimant of rights to said objects.

9. A method as in claim 8, wherein said business transaction includes at least one of: a purchase of an object, a rental of an object.

10. A method as in claim 8, wherein said business transactions include binding commitments by the user and an agent for a claimant of rights to that object.

11. A method as in claim 1, wherein said set of attributes are responsive to one or more of (a) information received from a Radio Frequency Identification Device, (b) a hash of a digital stream of data, (c) a digital versatile disk hash.

12. A method as in claim 1, wherein said database is protected against unauthorized modification.

13. A method as in claim 1 wherein said set of attributes includes at least one of: (a) owned, (b) right to play, (c) authorized, (d) downloaded, (e) previously played, (f) not authorized.

14. A method as in claim 1, wherein the database is either remote from the user or else protected against tampering by the user.

15. A method as in claim 1, wherein said steps of maintaining said database include
receiving information from a user indicating an error in said database; and
correcting said error in response to a result of said steps of receiving.

16. A method as in claim 15, wherein said steps of correcting include replacing information in said database with received information.

17. A method as in claim 15, wherein said steps of correcting are responsive to ownership changes performed external to said steps of maintaining.

18. A method as in claim 1, wherein said steps of changing include
determining a success result of an attempt to change any one of said attributes;
maintaining said database in response to said success result.

19. A method as in claim 18, wherein
said success result includes one or more of: success, failure, incompatibility, lack of adequate storage.

20. A method as in claim 18, including steps of
receiving one of a plurality of alternative actions to take in response to said success result.

21. A method as in claim 18, including steps of
prompting the user for permission to remedy success results other than a complete success.

22. A method as in claim 1, wherein said displayable forms include varying at least one of (a) luminance, (b) animation, (c) alpha-numeric characters, (d) 19 highlighting, (e) hue, (f) filtered hue.

23. A method as in claim 1, wherein said user is informed of each of said set of attributes associated with each said object as a result of said presenting.

24. A method as in claim 1, wherein said steps of presenting include steps of choosing and positioning said set of screen elements on a display, said steps of choosing and positioning being responsive to at least one of said attributes.

25. A method as in claim 1, wherein said steps of presenting include a measure of distance between a first element and a second element on said display being computed responsive to a measure of distance between a first object and a second object corresponding to those elements.

26. A method as in claim 1, wherein said steps of presenting include presenting each said screen element on a display in response to at least one of
a guide or mosaic format;
a measure of distinctness derived from a comparison of a first object to a second object;
a three-dimensional tour, said tour including a three-dimensional representation of a store;
a connectedness graph.

27. A method as in claim 1, wherein said steps of receiving include initiating a business transaction to obtain rights to said object.

28. A method as in claim 27, wherein said business transaction includes a grant of at least some rights to said object.

29. A method as in claim 27, wherein the object is delivered to said user.

30. A method as in claim 29, wherein said steps of updating of said database are performed responsive to at least one of: sending or shipping of said object, confirmation of delivery of said object.

31. A method as in claim 30, wherein said steps of updating include at least one of
calculating the hash of the binary content on a DVD,
receiving a signal from a RFID tag physically attached to the object.

32. A method as in claim 27, wherein said business transaction includes at least one of: a purchase of an object, a rental of an object.

33. A method as in claim 27, wherein said business transactions include binding commitments by the user and an agent for a claimant of rights to that object.

34. A method as in claim 1, wherein said steps of receiving include both said user and an input device.

35. A method as in claim 1, wherein said selection is responsive to at least one of (a) a region of a display screen selected by a user, (b) a preference of one or more users, (c) activation of controls on a touch panel.

36. A method as in claim 35, wherein said preference is used without disclosing reasons for said preference.

37. A method as in claim 1, wherein said steps of changing are responsive to at least one of: sending or shipping of said object, confirmation of delivery of said object.

38. A method as in claim 1, wherein said steps of changing one or more of said set of attributes by a user has the effect of making it easier for the user to further change said one or more of said set of attributes by completing a business transaction.

39. A method as in claim 38, wherein said business transaction includes purchase or licensing of at least one said object.

40. A method as in claim 1, wherein said steps of changing indicate a set of newly obtained ownership rights.

41. A method as in claim 1, wherein said steps of changing are responsive to one or more steps of
receiving a selection of one or more objects;
performing an action responsive to user rights in said objects;
executing a business transaction to acquire at least one of said objects;
completing a collection of objects responsive to said executing.

42. A method as in claim 41, wherein said objects include media streams.

43. A method as in claim 41, wherein said steps of completing include a collection of objects preferred by one or more individuals without said one or more individuals having to reveal their reasoning for including or excluding any said object in said collection.

44. A method, including steps of
selecting an object for presentation, said object associated with at least one attribute received at a first device from a remote second device indicating the status of a right of use;
presenting said object in a displayable form responsive to said attribute; and
obtaining by a user, a right of use to said object.

45. A method as in claim 44, wherein said steps of obtaining occur near at least one of
performance of the step of selecting an object for presentation;
performance of the step of presenting said object in a displayable form responsive to said attribute.

46. A method as in claim 44, wherein said steps of obtaining include completing a business transaction.

47. A method as in claim 46, wherein completing a business transaction alters said at least one attribute indicating the status of a right of use.

48. A method as in claim 46, wherein said business transaction includes at least one of: a purchase of an object, a rental of an object.

49. A method as in claim 46, wherein said business transactions include binding commitments by the user and an agent for a claimant of rights to that object.

50. Apparatus including
a set of screen elements, each element of said set of screen elements being representative of at least one object;
a set of attributes associated with each said object in a database, said set of attributes including at least one attribute that indicates the rights of a user with respect to said object, and said set of attributes including at least one attribute that indicates the status of a business transaction, said steps of maintaining including updating said database from time to time;
a signal to a display indicative of a presentation choice of at least some of said elements in one of a plurality of displayable forms, said displayable forms responsive to at least one of said set of attributes;
a signal indicating a selection of at least one of said elements by a user; and
a signal indicating an attempt to change at least one attribute of said elements in response to said steps of receiving.

51. Apparatus as in claim 50, wherein said business transaction includes at least one of: a purchase of an object, a rental of an object.

52. Apparatus as in claim 50, wherein said business transactions include binding commitments by the user and an agent for a claimant of rights to that object.

53. Apparatus as in claim 50, wherein said at least one object includes digital data.

54. Apparatus as in claim 50, wherein said at least one object includes a physical object.

55. Apparatus as in claim 50, wherein at least some of set of screen elements includes a pictorial representation of at least a portion of said object those said elements are representative of.

56. Apparatus as in claim 50, wherein said set of attributes includes at least one of: owned, not owned, scheduled for sales release, scheduled for theatrical release, currently in theatrical release, currently not available, recently played, in transit.

57. Apparatus as in claim 50, including, coupled to at least one said attribute that indicates the status of a business transaction, a detector responsive to the occurrence of a business transaction between a user and an agent for a claimant of rights to said objects.

58. Apparatus as in claim 57, wherein said business transaction includes at least one of: a purchase of an object, a rental of an object.

59. Apparatus as in claim 57, wherein said business transactions include binding commitments by the user and an agent for a claimant of rights to that object.

60. Apparatus as in claim 50, including, coupled to at least one of said set of attributes, a detector responsive to one or more of (a) information received from a Radio Frequency Identification Device, (b) a hash of a digital stream of data, (c) a digital versatile disk hash.

61. Apparatus as in claim 50, including an element capable of protecting said database against unauthorized modification.

62. Apparatus as in claim 50 wherein said set of attributes includes at least one of: (a) owned, (b) right to play, (c) authorized, (d) downloaded, (e) previously played, (f) not authorized.

63. Apparatus as in claim 50, wherein the database is either remote from the user or else include an element capable of protecting said database against tampering by the user.

64. Apparatus as in claim 50, including
a signal indicating information from a user indicating an error in said database; and
an element capable of correcting said error in response to said information.

65. Apparatus as in claim 50, wherein said signal indicating an attempt to change is coupled to said database.

66. Apparatus as in claim 50, wherein said displayable forms include a variance in at least one of (a) luminance, (b) animation, (c) alpha-numeric characters, (d) highlighting, (e) hue, (f) filtered hue.

67. Apparatus as in claim 50, wherein said user is informed of each of said set of attributes associated with each said object as a result of said presenting.

68. Apparatus as in claim 50, wherein said presentation choice includes at least one of: a choice of at least one screen element on a display, a position of at least one screen element on a display, said choice and said position being responsive to at least one of said attributes.

69. Apparatus as in claim 50, wherein said presentation choice includes a measure of distance between a first element and a second element on said display being computed responsive to a measure of distance between a first object and a second object corresponding to those elements.

70. Apparatus as in claim 50, wherein said presentation choice includes a choice of at least one screen screen element on a display in response to at least one of a guide or mosaic format;
a measure of distinctness derived from a comparison of a first object to a second object;
a three-dimensional tour, said tour including a three-dimensional representation of a store;
a connectedness graph.

71. Apparatus as in claim 50, wherein said signal indicative of a selection is responsive to a business transaction relating to rights to said object.

72. Apparatus as in claim 71, wherein said business transaction includes a grant of at least some rights to said object.

73. Apparatus as in claim 71, wherein the object is delivered to said user.

74. Apparatus as in claim 73, including a signal coupled to said database, that signal being responsive to at least one of: an event of sending or shipping of said object, an event of confirmation of delivery of said object.

75. Apparatus as in claim 74, including a signal indicative of at least one of
the hash of the binary content on a DVD,
a signal from a RFID tag physically attached to the object.

76. Apparatus as in claim 71, wherein said business transaction includes at least one of: a purchase of an object, a rental of an object.

77. Apparatus as in claim 71, wherein said business transactions include binding commitments by the user and an agent for a claimant of rights to that object.

78. Apparatus as in claim 50, including a user input device.

79. Apparatus as in claim 50, wherein said signal indicative of a selection is responsive to at least one of (a) a region of a display screen selected by a user, (b) a signal indicative of a preference of one or more users, (c) a touch panel.

80. Apparatus as in claim 79, wherein said signal indicative of a preference excludes information disclosing reasons for said preference.

81. Apparatus as in claim 50, including a signal coupled to said database, that signal being responsive to at least one of: an event of sending or shipping of said object, confirmation of delivery of said object.

82. Apparatus as in claim 50, wherein said signal indicative of an attempt to change includes information relating to a set of newly obtained ownership rights.

83. Apparatus as in claim 50, wherein said steps of signal indicative of an attempt to change includes information relating to at least one of:
a selection of one or more objects;
an action responsive to user rights in said objects;
a business transaction to acquire at least one of said objects;
a collection of objects.

84. Apparatus as in claim 83, wherein said objects include media streams.

85. Apparatus including
an object capable of presentation, said object associated with at least one attribute received at a first device from a remote second device indicating the status of a right of use;
a presentation choice associated with said object; and
a signal indicative of a status of obtaining, by a user, a right of use to said object.
